(19) United States
(12) Patent Application Publication
(10) Pub. No.: US 2007/0282653 A1
(43) Pub. Date: Dec. 6, 2007

(54) CATALOG BASED SERVICES DELIVERY MANAGEMENT

(76) Inventors: Ellis Edward Bishop, Austin, TX (US); Tian Jy Chao, Bedford, NY (US); Pankaj Dhoolia, Dadri (IN); John Patrick Hogan, Stone Ridge, NY (US); Rajesh Jaluka, Poughkeepsie, NY (US); Santhosh Babu Kumaran, Peekskill, NY (US); David Matthew Loewenstern, New York, NY (US); Heiko Hary Ludwig, New York, NY (US); Ann M. Moyer, Woodstock, NY (US)

Correspondence Address: CAHN & SAMUELS, LLP, 2000 P. STREET, NW, SUITE 200, WASHINGTON, DC, 20036, US

(21) Appl. No.: 11/422,113

(22) Filed: Jun. 5, 2006

(51) Int. Cl. G06F 9/46

(52) U.S. Cl. 705/8

(57) ABSTRACT

Disclosed is an apparatus and method for implementing a repository of services. One embodiment describes a method consisting of defining a plurality of atomic services, providing at least one service composition from the definition of the plurality of atomic services, and combining at least one atomic service associated with the at least one service composition with a service plan. The method further consists of providing a service plan that describes the control and data flow between the at least one of the plurality of atomic services and the at least one service composition.

### FIELD OF THE INVENTION

The invention relates to the enablement of multi provider, multi customer, and dynamic services delivery.

### BACKGROUND

In today's highly competitive economic environment, IT executives are challenged to reduce costs and increase the quality, scope and volume of technical services required to meet their company's needs. This challenge has been manageable to date because service responsibilities have been spread between many independent and frequently geographically diverse groups who operate with efficient, best of breed practices. However, the use of many different groups for delivery has created the following issues:

Business Issues:
Inconsistent and non-standard processes;
Service Level Agreements that cannot be tracked nor enforced;
Ad-hoc service delivery (no workflow), each request treated as a one-off Inefficient engagement;
Cost and prices are base lined in the catalog by overall service and by task that enables accurate customization pricing;
Access to historic data on service costs;
Expensive services can be identified and optimized during engagement
Visibility to the patterns of Requests for Service (RFSs) submitted after contracts are signed;
What they are requesting;
What service area(s) are prevalent in requests; and
Processes are not audible as there is no written record.

### Customer End User Issues:

IT is hard to work with, mismatched expectations of deliverable to cost;
IT doesn't understand my business—they expect me to be a technology expert;
IT's costs are too high, delivery is too slow, orders lost;
Why does it take so long for a simple request; and
No single place to place a request.

Others have tried different approaches for providing services, such as the following prior art.

U.S. Patent Application 2002/0169649A1 discloses a method for automated and efficient provision of professional legal documents and services. The provision of legal forms to a user by a lawyer is facilitated over an electronic communications link. The method entails establishing a communications link to permit a lawyer to provide legal advice to a user, receiving payment for the legal advice based on user information, and restricting access by the lawyer to a portion of the user information to maintain anonymity. The method generates customized situation-specific legal documents directly to the user's computer, and it does so without the risk of conflicts of interest, thereby substantially simplifying and streamlining the rendering of legal advice to users. Immediate rich text format (rtf) document delivery is accomplished directly to a secondary browser window so that subscribers are free to modify the documents at will. U.S. Patent Application 2004/0024627A1 discloses a Business Technology Relationship Model (BTRM) is a method for abstracting and modeling the relationships that exist between technical infrastructure components and specific business processes, resulting in a proprietary Business Technology Relationship Protocol. The method defines a dependency approach to technical infrastructure delivery and management by creating the 13 Layer BTRM Dependency/Impact Hierarchy, a modeled understanding of the dependencies that specific business processes have on specific technical infrastructure components, including the interdependencies between modeled business and technical objects. When the resulting Relationship Protocol is placed into software, the BTRM Method improves the delivery and management of technology infrastructure and technology support services spanning a diverse set of industries and business disciplines.

U.S. Patent Application 2005/0203917A1 discloses a system and method designed to optimize the delivery of information on demand via wired or wireless connections. Dynamic information such as weather data can be delivered as compressed text, images, charts, buoy data, radar, GRIB files, and many more formats. Numerous continuously updated products can be delivered to a user of a client application on demand by the push of a button. The user can generate a batch folder having a list of data products to download. The data list in the batch folder can be requested from a server using a single command. The system and method can be configured to immediately connect to a server via a wireless connection or email, including satellite phone and HF/Pactor Radio, and downloads the requested data. After the download the client can be configured to automatically display the requested data.

U.S. Patent Application 2006/0069607A1 disclose tools and related methods for business organizations to quickly obtain, preserve and exploit new or improved assets, skills or capabilities that are important to growth and success. The tools and processes disclosed are adapted to preserve one or more target elements of an acquired target business organization by outsourcing those target elements during the integration period that follows the merger or acquisition. This outsourcing of one or more target elements during the integration period that necessarily follows a merger or acquisition deal creates various inherent advantages over the traditional merger, acquisition, or outsourcing approaches as described herein, and these advantages help to deliver benefits of the target element in speedy fashion and with undiminished quality.

U.S. Pat. No. 6,438,594 discloses a system, method, and article of manufacture are provided for delivering service via a locally addressable interface. A plurality of globally addressable interfaces and a plurality of locally addressable interfaces are provided. Access is allowed to a plurality of different sets of services from each of the globally addressable interfaces and the locally addressable interface. Each interface has a unique set of services associated therewith. The globally addressable interfaces are registered in a naming service for facilitating access thereto. Use of the locally addressable interfaces is permitted only via the globally addressable interfaces or another locally addressable interface.

### SUMMARY OF THE INVENTION

An exemplary feature of this invention is a method for implementing a repository of services. The method consists of defining a plurality of atomic services, providing at least one service composition from the definition of the plurality of atomic services, and combining at least one atomic service associated with the at least one service composition with a service plan. The method further consists of providing a service plan that describes the control and data flow between the at least one of the plurality of atomic services and the at least one service composition.

Another exemplary feature of this invention is a method of providing a repository of service providers, providing a repository of service provider capabilities of delivering the atomic services, conducting an extended service order process by accessing the at least one service composition, and retrieving the service plan of the at least one service composition. The method further consists of retrieving the repository of service provider capabilities, selecting at least one of the service providers for each atomic service definition; and executing the service plan by invoking the at least one atomic services offered by the at least one of the selected service providers according to a control flow of the service plan as part of the at least one service composition.

A further exemplary feature of this invention is a method of providing a repository of account records that represent as offered services for each account a set of service compositions to which the accounts are subscribed and the account-specific requirements of each the account on service compositions.

Yet another exemplary feature of this invention is a method of providing the repository of account records with a choice of preferred service providers for each account.

Another exemplary feature of this invention is a method of providing an end-to-end life-cycle management for each repository.

A further exemplary feature of this invention is a method of providing an end-to-end life cycle management with an atomic service definition life-cycle.

Another exemplary feature of this invention is a method of providing an end-to-end life cycle management with a service provider capability life-cycle.

Yet another exemplary feature of this invention is a method of providing an end-to-end life cycle management with a service composition life-cycle.

Still another exemplary feature of this invention is a method of providing an end-to-end life cycle management with an offered service life-cycle.

Various other objects, features, and attendant advantages of the present invention will become more fully appreciated as the same becomes better understood when considered in conjunction with the accompanying drawings, in which like reference characters designate the same or similar parts throughout the several views.

### BRIEF DESCRIPTION OF THE DRAWINGS

FIG. 1 illustrates a data structure of an Atomic Service Definition according to an embodiment of the present invention.

FIG. 2 illustrates a data structure of the repository for a Service Provider according to an embodiment of the present invention.

FIG. 3 illustrates a data structure of the repository for a Service Provider Capability according to an embodiment of the present invention.

FIG. 4 illustrates a data structure of the repository for a Service Composition according to an embodiment of the present invention.

FIG. 5 illustrates a data structure of the repository for an Offered Service according to an embodiment of the present invention.

FIG. 6 illustrates a structure of a Service Composition according to an embodiment of the present invention.

FIG. 7 illustrates an execution process for executing a Service Composition according to an embodiment of the present invention.

FIG. 8 illustrates an execution process for executing a Service Composition with multiple service providers according to an embodiment of the present invention.

FIG. 9 illustrates a management scheme of Atomic Service Definitions (ASD) according to an embodiment of the present invention.

FIG. 10 illustrates a management scheme of Service Providers according to an embodiment of the present invention.

FIG. 11 illustrates a management scheme of a Service Provider Capability according to an embodiment of the present invention.

FIG. 12 illustrates a management scheme of a Service Composition according to an embodiment of the present invention.

FIG. 13 illustrates a management scheme of an Offered Service according to an embodiment of the present invention.

FIG. 14 illustrates a hardware implementation for performing dynamic services delivery according to an embodiment of the present invention.

FIGS. 15 and 16 illustrate a software deployment implementation for performing dynamic services delivery according to an embodiment of the present invention.

FIGS. 17A, 17B and 17C illustrate still another software deployment implementation for performing dynamic services delivery according to an embodiment of the present invention.

### DETAILED DESCRIPTION

An embodiment of the present invention provides an online, database driven, catalog of service offerings is needed to bring order to IT offerings. Construction of this catalog must be in synch with the generic basic services the IT organization has been approved for offering. A mechanism for constructing any higher level, complex and or customized services must be provided from basic generic services. This is called a tiered service catalog.

To prevent rogue or non-conforming offerings, a mapping back to the approved lower level services must be accommodated in the catalog. The catalog entry format should contain at the lowest layer a basic service definition including information about cost, performer tasks, Service level agreements, and outside systems interfaces. Once the catalog of general offerings both basic and complex is defined, customer specific services can then be put in place. The customer offerings are those the customer has approved for usage in their environment. These again should be mappable back to the original basic services.

The present invention provides an embodiment for the enablement of multi-service provider, multi-client service delivery by a delivery services catalog representing service provider capabilities, service delivery processes, and customer delivery preferences regarding processes and service providers.

The present invention centrally maintains standard Service Delivery processes and work decompositions, while enabling multiple service providers to perform work packages (atomic services) in these processes and manage service customers' subscriptions and account-specific choices of service properties at the same time.

An embodiment of this invention includes a mechanism based on an information model of service definitions of the service repository, the processes that define the life-cycle of the information in the repository and the main service order process that is executed based on the context of the repository.

Various embodiments of the present invention will be described with reference to the following figures.

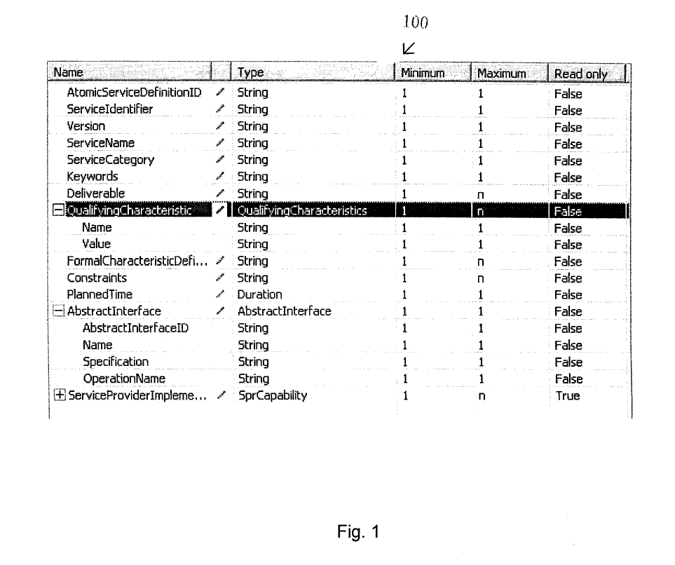

FIG. 1 shows data structure of an Atomic Service Definition 100. The Atomic Service is invoked and executed in a way a method or a procedure of a program is being executed, receiving input parameters, returning an output and having side effects that are integral parts of the service, for example, applying a patch to a server.

An Atomic Service Definition (ASD) 100 specifies a type of atomic service that can be performed by one or more service providers. It is the basis of the repository.

The ASD 100 may contain the data elements as outlined below:

The AtomicServiceDefinitionID is a unique identifier of the ASD that is maintained in the repository. It is assigned by the system.

The ServiceIdentifier is a unique ID that can be interpreted by a user of the repository.

The Version identifies the version of the ASD. All versions are kept in the repository.

Multiple versions can be in use concurrently, which is outlined later, in the discussion of the life-cycle.

ServiceName is a semantically meaningful description of the service, e.g., “Windows OS Patch Service”.

A Service Category defines the category which applies to the service, e.g., OS Maintenance. Service categories allow structured organization and search of ASDs for the user.

Keywords are a comma-separated list of terms that ease search of ASDs by users.

The Deliverable outlines the work to be achieved when executing the service, e.g., applying a patch to a server node. This description is in natural language, understandable to users and providers.

A Qualifying Characteristic defines in a natural language a property and a constraint that a service provider for this ASD has to comply with, e.g., a specific execution time being required to be less than 24 hours. It is meant to be verified by humans.

A Formal Characteristic Definition comprises a formal definition of properties of a service, e.g., service duration, local availability, etc. Each service provider is expected to provide values for these properties when signing up to provide service corresponding to an ASD.

A Constraint are a formal definition of a logic predicate over Qualifying Characteristics specified in a machine interpretable language such as the OMG Object Constraint Language (OCL), or SQL expressions. Using constraints, a definer of an ASD can express requirements on service provider such as service duration must be less than 24 hours. The constraints can be automatically verified by an interpreter.

The Planned Time defines the estimated amount of time to perform an atomic service instance.

An Abstract Interface defines formally the interface to the service. It has its own ID and Name. The actual content of the formal definition is contained in the specification attribute. The content is defined in the Web Service Description Language (WSDL), defining a service port type.

The OperationName defines the specific operation within the port type that constitutes the service, as a port type may contain multiple operations. Other interface definition languages such as CORBA IDL can be used.

The Service Provider Implementations refer to the set of service providers who implement this ASD, defined in Service Provider Capabilities (see below).

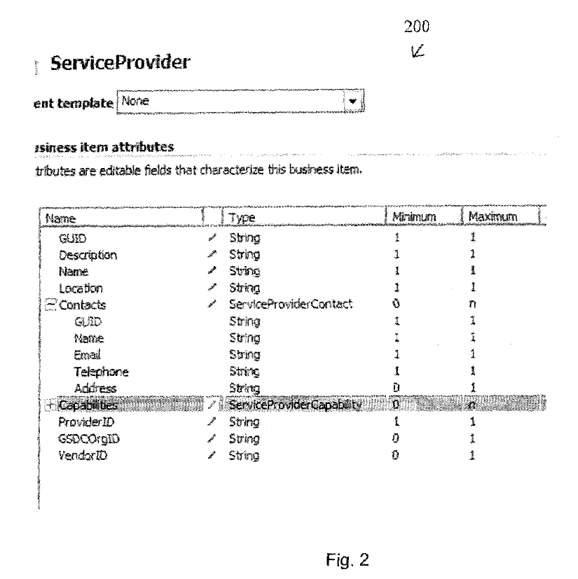

FIG. 2 illustrates a data structure of the repository for a Service Provider.

The Service Provider 200 definition captures the information on an organization that can provide service in the context of this service delivery platform. A Service Provider refers to an organizational unit that has resources to perform service and decides independently, from the system's point of view, which service to offer through the system. Service providers can be within the same company or other legal entity or can be entirely independent.

The service provider 200 may have the following attributes:

The GUID is a unique identifier generated by the system.

The description contains a natural language description of the service provider.

The name gives the name of the service provider.

The location provides the name of the location where the service provider resides. This is important if an Atomic Service requires a specific location of service, e.g., for desk side services, or does not allow services to be performed at a specific location, e.g., specific countries.

A set of contacts identifies people who can be contacted to discuss service. Contacts have a unique ID (GUID), a Name, as well as Email, Telephone and Address information.

The Provider ID is a human-understandable ID that refers to a specific provider.

A GSDCOrgID is the ID of an internal service delivery team in a Global Service Delivery Center, in case the provider is internal.

A VendorID is an ID of an external service provider and refers to information in the vendor database of organization operating the service delivery platform.

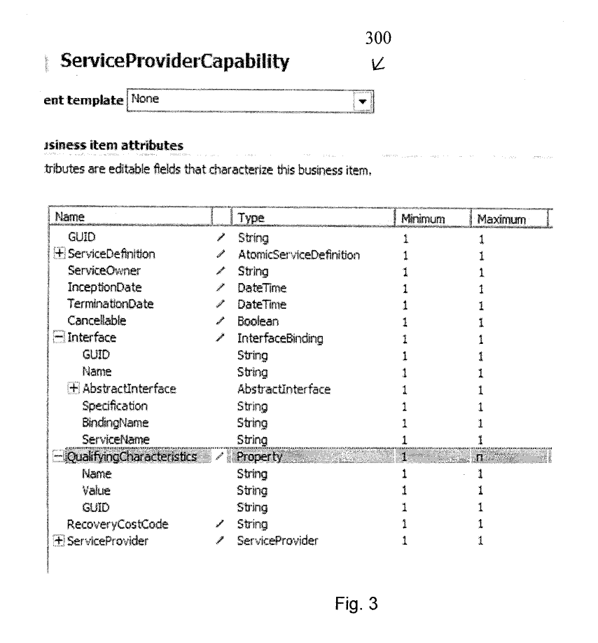

FIG. 3 illustrates a data structure of the repository for a Service Provider Capability 300.

The Service Provider Capability 300 states that a service provider is able and prepared to perform an ASD. Whether a service provider will perform service for a particular service request depends upon agreement between the service delivery management and the provider at the time of coordinating the specific service request for which the atomic service to be performed.

The service provider capability 300 could have the following set of attributes:

The GUID is the unique, system-generated ID.

The Service Definition is a reference to the ASD which a service provider will provide.

The Service Provider refers to the service provider in question.

The service owner is the name of a contact person at the service provider for this specific service.

The inception date is the date when the service provider will start providing service for this ASD.

The termination date is the date when the service provider will cease to accept requests for the ASD in question.

The attribute Cancellable defines, whether a service provider allows to request a cancellation of a requested atomic service while it is being performed.

The Interface outlines, the specific interface information required to bind to the specific service provider. It has its own ID, GUID, a name, a reference to an AbstractInterface, the specification containing the WSDL of the interface description referring to the specification of the abstract interface description, the name of the binding to be used and the name of the service.

Also, there is a recovery cost code for accounting purposes.

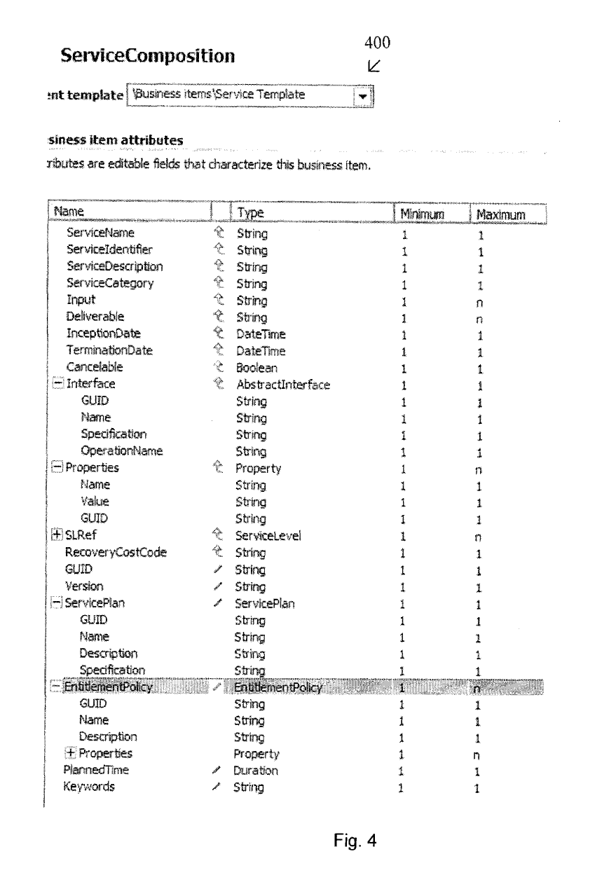

FIG. 4 illustrates a data structure of the repository for a Service Composition 400. Multiple ASDs are composed into a Service Composition, which corresponds to a granularity of service that a customer would like to order. The core of the Service Composition is the service plan, which defines the choreography between the ASDs.

Beyond the service plan, the Service Composition 400 could have the following set of attributes:

The GUID is a unique identifier of the Service Composition that is maintained in the repository. It is assigned by the system.

The ServiceIdentifier is a unique ID that can be interpreted by a user of the repository. The Version identifies the version of the Service Composition. All versions are kept in the repository. Multiple versions can be in use concurrently, which is outlined later, in the discussion of the life-cycle.

ServiceName is a semantically meaningful description of the service, e.g., “Windows OS Patch Install”.

A Service Category defines the category which applies to the service, e.g., OS Maintenance. Service categories allow structured organization and search of Service Compositions for the user.

Keywords are a comma-separated list of terms that ease search of Service Compositions by users.

The ServiceDescription outlines in natural language the Service Composition to those browsing the repository.

The inception date is the date when the service compositions will be available to customers.

The termination date is the date when requests for the service composition will ceased to be taken.

The Input is a natural language description of the inputs required by the system.

The Deliverable is a natural language description of the results that the service composition will have.

The attribute Cancellable defines, whether a service customer is allowed to request a cancellation of a requested service composition while it is being performed.

The Interface defines formally an abstract interface of the service composition in WSDL, in the same way than the abstract interface of an ASD.

A Service Composition can have a set of properties that are defined as name value pairs.

The RecoveryCostCode defines an accounting code for charging the service composition to accounts.

The Planned Time defines the typical time required to deliver the type of service composition.

A Service Level Reference points to a definition of a Service Level. This typically contains a definition of service level parameters, constraints over these parameters, and costing information outlining differences in cost to the best effort service. A service composition may be offered at multiple service levels.

The service plan is the core information of the service composition. It has a unique ID GUID, a Name, a natural language description and a formal Specification of the service plan in a suitable formal language, e.g., the Business Process Execution Language (BPEL) for Web Services.

There can be any number of service compositions in a service delivery platform.

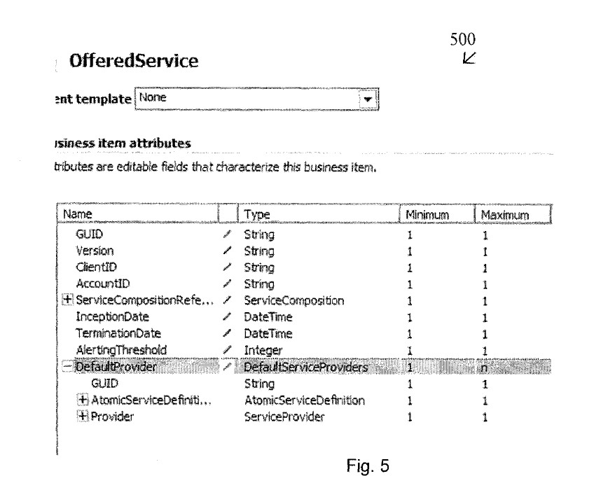

FIG. 5 illustrates a data structure of the repository for an Offered Service 500.

The Offered Service 500 is a Service Composition as offered to a particular account. Besides establishing the association between a particular account and a particular service composition, the Offered Service captures the specifics as to how the account wants the service to be delivered.

The Offered Service 500 could have the following attributes:

The GUID is the unique ID of the Offered Service and is generated automatically.

The Version defines the specific version of the Offered Service.

The ClientID identifies the customer organization for which the service is provided.

The AccountID identifies the specific account of a Client organization which contracted the service. A client may have multiple accounts.

The Service Composition Reference points to the Service Composition that is subject to this offered service.

The inception date is the date when the service will be available to the specified account.

The termination date is the date when requests for this service will ceased to be taken from the specified account.

The Alerting Threshold defines a percentage value for SLA compliance at which notifications will be sent to the customer, e.g., if 90% of the planned time for a service is reached.

There can be Default Provider specifications for all Atomic Services of the Service Composition to which the Offered Service refers. By this way, specific provider preferences of an account can be taken into consideration.

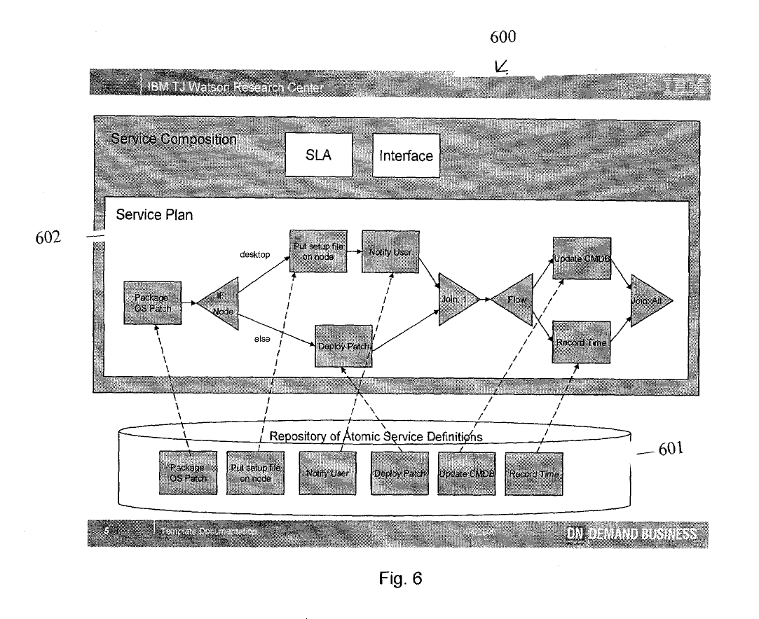

FIG. 6 illustrates a structure of a Service Composition 600.

The service composition 600 includes a set of atomic service compositions and the service plan that defines the data and control flow between them. As illustrated in FIG. 6, the relationship between atomic service definitions 601, the service plan 602 and within the service composition 600 is shown.

The service plan 602 contains the service composition specification. It typically is a BPEL specification defining the control and data flow between atomic services.

Service Designers use the service design application to specify a service composition. In this preferred embodiment, a Web application is used to create a service composition and a Windows client application is used to create the service plan, generate a BPEL file and import it into the service repository, complementing the data collected by the Web application.

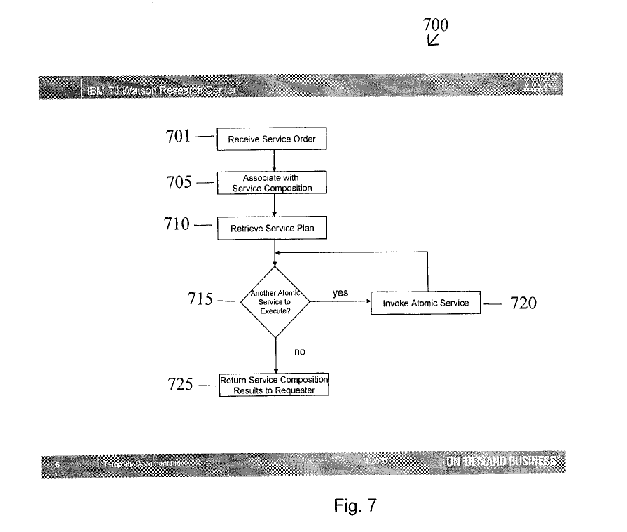

FIG. 7 illustrates an execution process 700 for executing a Service Composition. In particular, it is described how service orders are executed according to the specifications in the repository.

A service order is received 701 by the service delivery platform from an employee of a client organization, indicating the account against which it subscribed. Part of the service order received is the service order data set. The service order is mapped 705 against a service composition. The request type name is matched against the name of the service composition to which an offered service that is subscribed by the sending account. The platform retrieves 710 the service plan associated with the service composition that has been identified. The set of atomic services and their invocation order is also retrieved. An atomic service whose preceding atomic services have been fulfilled is called ready. If not all atomic services have been executed, at least one atomic service is ready. The set ready atomic service is computed 720. All ready atomic services are executed, supplying the service order data to the service. Upon completion of the execution of an atomic service, the ready status of the respective service is updated 715. This is repeated until all atomic services are executed. Finally, the result data of the execution of the atomic services is returned to the service requester 725.

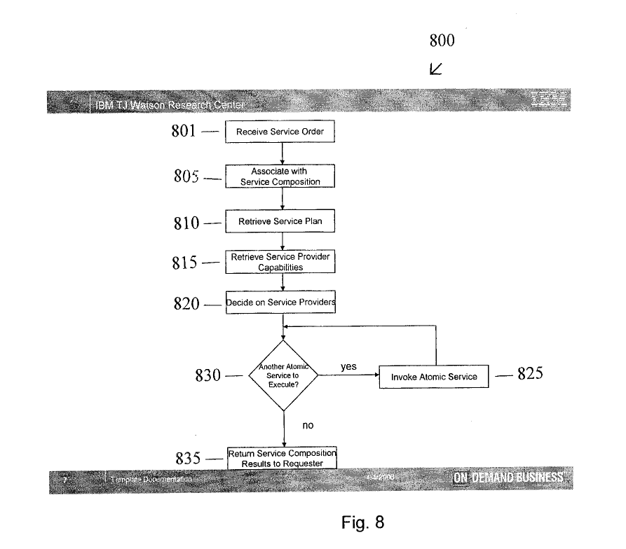

FIG. 8 illustrates an execution process 800 for executing a Service Composition with multiple service providers.

An embodiment of the present invention is the ability to direct work to multiple service providers. The execution process 800 outlines how a service request is being executed considering multiple service providers. The service order is received 801, associated 805 with a service composition and a service plan is retrieved 810, as in the execution process in FIG. 7. Subsequently, for all ASDs that are contained in the Service Composition, the set of Service Provider Capabilities is retrieved 815. For each ASD a decision is made as to which provider of the ones associated with the service provider capabilities retrieved will perform this service. For this purpose, a decision maker 820 use will use a graphical user interface to enter his or her decision. Alternatively, a programmatic, automated decision-making algorithm can be used. Decision-making can also take into account the availability of service providers at the time of the service request. The set of atomic services and their invocation order is also retrieved. An atomic service whose preceding atomic services have been fulfilled is called ready. If not all of the atomic services have been executed but, at least one atomic service is ready, the set ready atomic service is computed 825. All ready atomic services are executed, supplying the service order data to the service. Upon completion of the execution of an atomic service, the ready status of the respective service is updated 830. This is repeated until all atomic services are executed. Finally, the result data of the execution of the atomic services is returned to the service requester 835.

The life cycle of all repository items are managed by processes that guarantee the consistency and viability of the items in the context of the rest of the repository state. In another embodiment of the invention, the life-cycle management processes are defined. The life-cycle management processes can include certification steps for critical design decisions. Other variations, simpler or more complex are easy to imagine within the scope of the present invention.

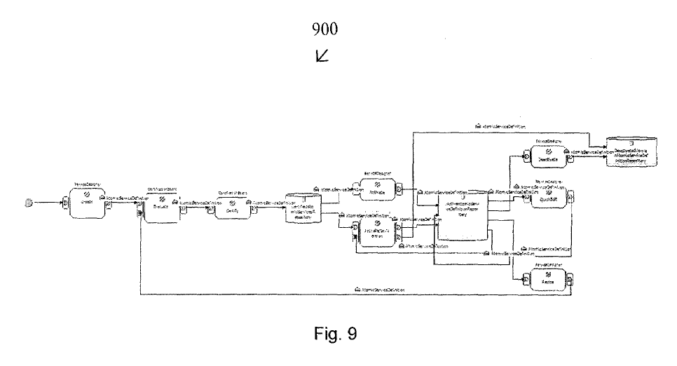

With reference to FIGS. 9-13, the box label denotes the name of the activity, the label on top of the box the role that performs the activity and the label of the edges defines the data flow.

FIG. 9 illustrates the management of Atomic Service Definitions (ASD).

Referring to FIG. 9, the life-cycle 900 of an ASD, the Service Designer takes all Design Decisions and has them approved by the Certification Board. After creating an ASD, the Certification Board evaluates the ASD and certifies it when it is of sufficient quality. Subsequently, the ASD can be activated, being put in the repository of active ASDs. There, a service designer can either quick-edit the ASD, i.e. applying only a minor change, or perform a proper revision of the ASD, which sends it back to certification. If a revision is created, the previous version stays active. When a revision is approved, the old version of the ASD is deactivated and put into the repository of deactivated ASD, the new version is activated. Also, active ASDs can be deactivated.

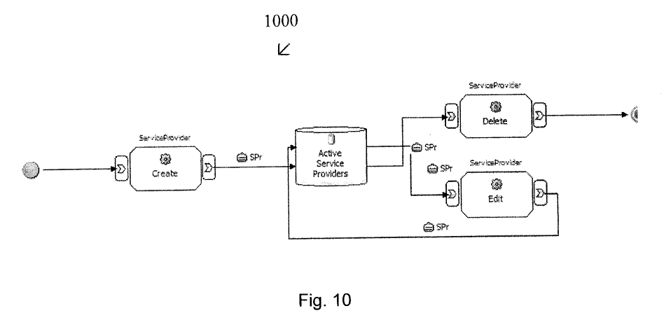

FIG. 10 illustrates the management of Service Providers.

Service Providers manage 1000 their properties in the system by themselves. After creation, a service provider becomes active immediately. It can edit its properties and delete itself without further approval.

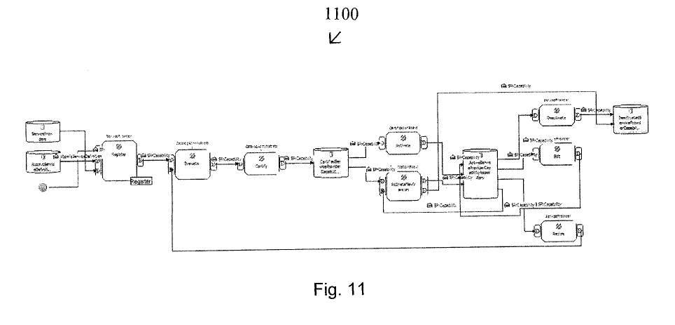

FIG. 11 illustrates the management of a Service Provider Capability.

While service providers can maintain their properties themselves, the management 1100 of their capabilities require certification by the Catalog Administrators and the activation of service provider capabilities is performed by the certification board. Based on the given set of ASDs and its own registration with the platform, a service provider registers a new service provider capability. Subsequently, the catalog administrators evaluate the service provider's claim to be able to perform a service according to an ASD and certify it, if this is the case. The Service Provider Capability is in state certified. Subsequently, the certification board can activate this capability. Service providers can edit activated in a minor way without further approval. However, revisions must be sent back to evaluation. As in the case of ASDs, the old version of a capability stays active. When the new revision is certified and activated, the old version is deactivated. Also, a current version can be deactivated, finishing the life-cycle of the service provider capability.

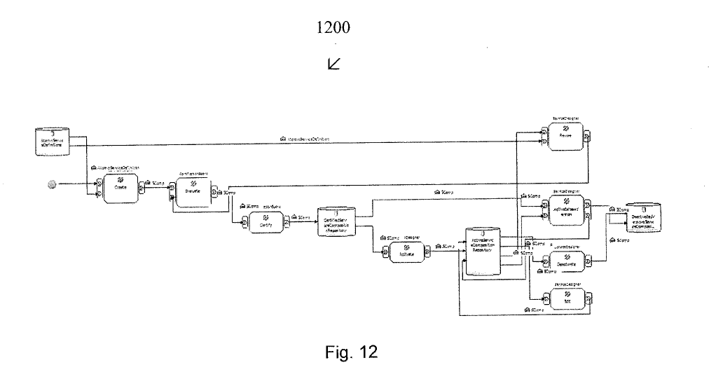

FIG. 12 illustrates the management of a Service Composition.

Referring to FIG. 12, the management 1200 of a service composition is mainly created by a service designer and is certified by a certification board. Building on the repository of ASDs, a service designer creates the service composition. After evaluation and certification by the certification board, the service designer can activate the service composition, making it usable by accounts. Service designers can apply minor edits without approval. Larger revisions must be re-evaluated, while the old version stays active. Upon activation of the revision, the old version is deactivated, i.e. no new service request can be submitted against the old version. Deactivation without supplying a new version ends the service composition's life-cycle.

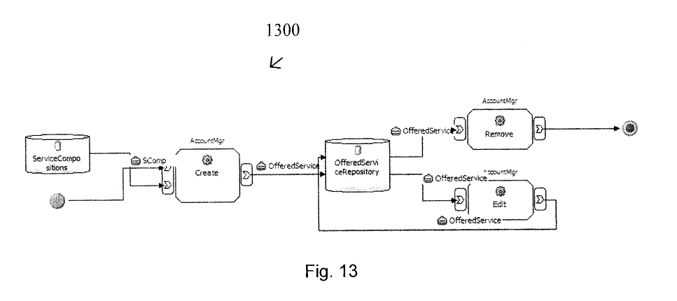

FIG. 13 illustrates the management of an Offered Service.

Referring to FIG. 13, the management 1300 of an Offered Service is done by an Account Manager. The account manager is fully responsible for the access of his or her account to services. Creation of Offered Services is based on the set of active service compositions. After creation, they can be immediately used to request services. They can be removed if the client should not access this service anymore, either due to contract expiration or a new version of the associated service composition being available and being planned for use by this client.

Another embodiment of the present invention may either manual or automated processes for controlling about mentioned management processes. Further users may use a Web application to manage the life-cycle according to the processes outlined above. This could comprises the Service Provider component for service provider registration and service provider capability management, the service designer component to create ASDs and Service compositions, and the Account Management component to manage Offered Services, either singularly or in combinations

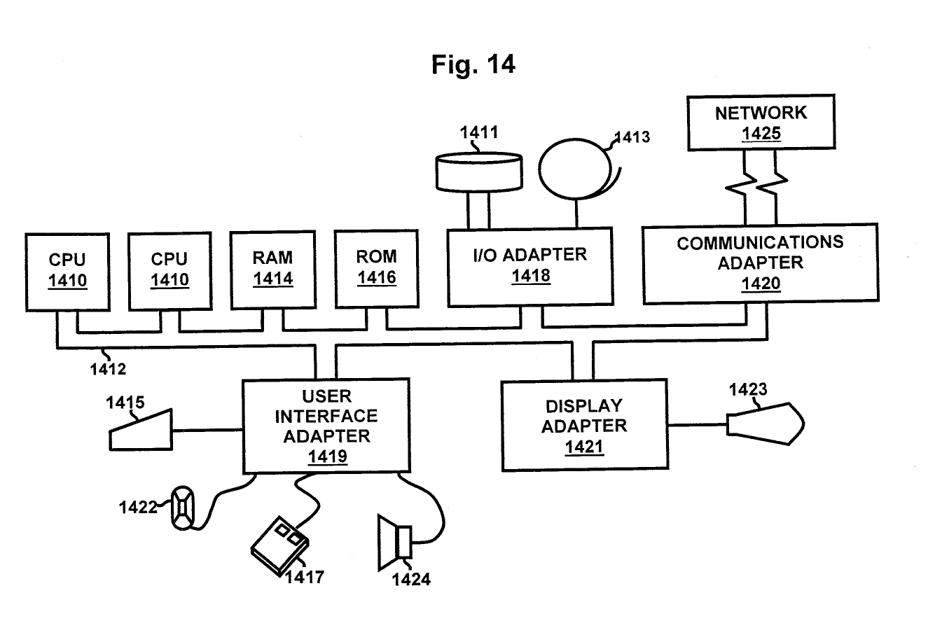

A representative hardware environment for practicing the embodiments of the invention is depicted in FIG. 14. This schematic drawing illustrates a hardware configuration of an information handling/computer system in accordance with the embodiments of the invention. The system comprises at least one processor or central processing unit (CPU) 1410. The CPUs 1410 are interconnected via system bus 1412 to various devices such as a random access memory (RAM) 1414, read-only memory (ROM) 1416, and an input/output (I/O) adapter 1418. The I/O adapter 1418 can connect to peripheral devices, such as disk units 1411 and tape drives 1413, or other program storage devices that are readable by the system. The system can read the inventive instructions on the program storage devices and follow these instructions to execute the methodology of the embodiments of the invention. The system further includes a user interface adapter 1419 that connects a keyboard 1415, mouse 1417, speaker 1424, microphone 1422, and/or other user interface devices such as a touch screen device (not shown) to the bus 1412 to gather user input. Additionally, a communication adapter 1420 connects the bus 1412 to a data processing network 1425, and a display adapter 1421 connects the bus 1412 to a display device 1423 which may be embodied as an output device such as a monitor, printer, or transmitter, for example.

It should also be obvious to one of skill in the art that the instructions for the technique described herein can be downloaded through a network interface from a remote storage facility or server.

The described techniques may be implemented as a method, apparatus or article of manufacture involving software, firmware, micro-code, hardware and/or any combination thereof. The term “article of manufacture” as used herein refers to code or logic implemented in a medium, where such medium may comprise hardware logic [e.g., an integrated circuit chip, Programmable Gate Array (PGA), Application Specific Integrated Circuit (ASIC), etc.] or a computer readable medium, such as magnetic storage medium (e.g., hard disk drives, floppy disks, tape, etc.), optical storage (CD-ROMs, optical disks, etc.), volatile and non-volatile memory devices [e.g., Electrically Erasable Programmable Read Only Memory (EEPROM), Read Only Memory (ROM), Programmable Read Only Memory (PROM), Random Access Memory (RAM), Dynamic Random Access Memory (DRAM), Static Random Access Memory (SRAM), flash, firmware, programmable logic, etc.]. Code in the computer readable medium is accessed and executed by a processor. The medium in which the code or logic is encoded may also comprise transmission signals propagating through space or a transmission media, such as an optical fiber, copper wire, etc. The transmission signal in which the code or logic is encoded may further comprise a wireless signal, satellite transmission, radio waves, infrared signals, Bluetooth, visible light signals, etc. The transmission signal in which the code or logic is encoded is capable of being transmitted by a transmitting station and received by a receiving station, where the code or logic encoded in the transmission signal may be decoded and stored in hardware or a computer readable medium at the receiving and transmitting stations or devices. Additionally, the “article of manufacture” may comprise a combination of hardware and software components in which the code is embodied, processed, and executed. Of course, those skilled in the art will recognize that many modifications may be made without departing from the scope of embodiments, and that the article of manufacture may comprise any information bearing medium. For example, the article of manufacture comprises a storage medium having stored therein instructions that when executed by a machine results in operations being performed.

Certain embodiments can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, certain embodiments can take the form of a computer program product accessible from a computer usable or computer readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries. Additionally, a description of an embodiment with several components in communication with each other does not imply that all such components are required. On the contrary a variety of optional components are described to illustrate the wide variety of possible embodiments.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently.

When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article. The functionality and/or the features of a device may be alternatively embodied by one or more other devices which are not explicitly described as having such functionality/features. Thus, other embodiments need not include the device itself.

Certain embodiments may be directed to a method for deploying computing instruction by a person or automated processing integrating computer-readable code into a computing system, wherein the code in combination with the computing system is enabled to perform the operations of the described embodiments.

At least certain of the operations illustrated in here in may be performed in parallel as well as sequentially. In alternative embodiments, certain of the operations may be performed in a different order, modified or removed.

Furthermore, many of the software and hardware components have been described in separate modules for purposes of illustration. Such components may be integrated into a fewer number of components or divided into a larger number of components. Additionally, certain operations described as performed by a specific component may be performed by other components.

The data structures and components shown or referred to are described as having specific types of information. In alternative embodiments, the data structures and components may be structured differently and have fewer, more or different fields or different functions than those shown or referred to in the figures.

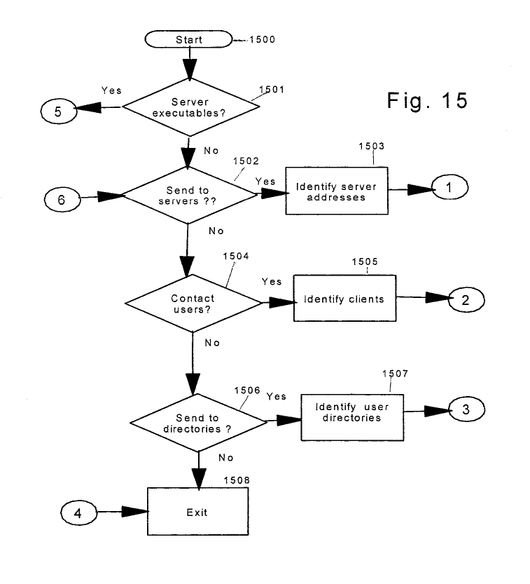

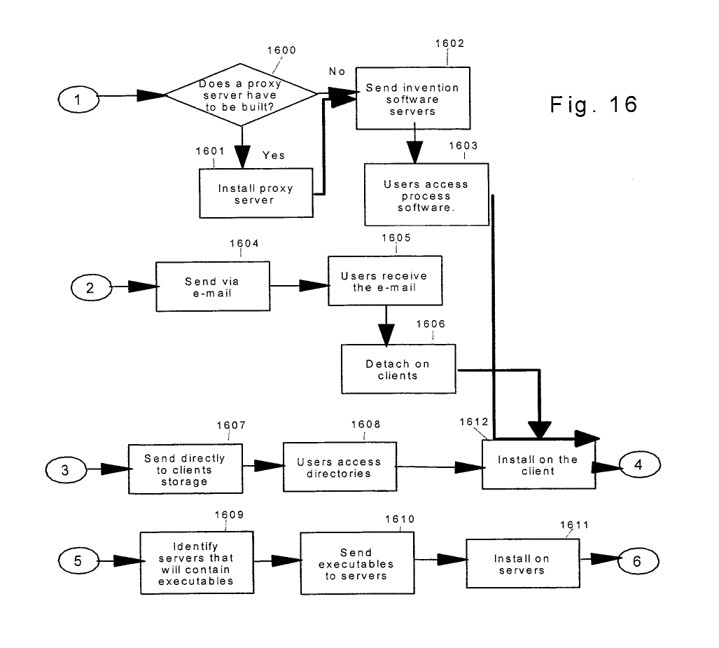

FIGS. 15 and 16 illustrate yet another software deployment implementation for using an embodiment of the present invention. Step 1500 begins the deployment of the process software. The first thing is to determine if there are any programs that will reside on a server or servers when the process software is executed 1501. If this is the case then the servers that will contain the executables are identified 1609. The process software for the server or servers is transferred directly to the servers' storage via FTP or some other protocol or by copying though the use of a shared file system 1610. The process software is then installed on the servers 1611.

Next, a determination is made on whether the process software is be deployed by having users access the process software on a server or servers 1502. If the users are to access the process software on servers then the server addresses that will store the process software are identified 1503.

A determination is made if a proxy server is to be built 1600 to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required then the proxy server is installed 1601. The process software is sent to the servers either via a protocol such as FTP or it is copied directly from the source files to the server files via file sharing 1602. Another embodiment would be to send a transaction to the servers that contained the process software and have the server process the transaction, then receive and copy the process software to the server's file system. Once the process software is stored at the servers, the users via their client computers, then access the process software on the servers and copy to their client computers file systems 1603. Another embodiment is to have the servers automatically copy the process software to each client and then run the installation program for the process software at each client computer. The user executes the program that installs the process software on his client computer 1612 then exits the process 1508.

In step 1504 a determination is made whether the process software is to be deployed by sending the process software to users via e-mail. The set of users where the process software will be deployed are identified together with the addresses of the user client computers 1505. The process software is sent via e-mail to each of the users' client computers. The users then receive the e-mail 1605 and then detach the process software from the e-mail to a directory on their client computers 1606. The user executes the program that installs the process software on his client computer 1612 then exits the process 1508.

Lastly a determination is made on whether the process software will be sent directly to user directories on their client computers 1506. If so, the user directories are identified 1507. The process software is transferred directly to the user's client computer directory 1607. This can be done in several ways such as but not limited to sharing of the file system directories and then copying from the sender's file system to the recipient user's file system or alternatively using a transfer protocol such as File Transfer Protocol (FTP). The users access the directories on their client file systems in preparation for installing the process software 1608. The user executes the program that installs the process software on his client computer 1612 then exits the process 1508.

The present software can be further deployed to third parties as part of an additional service wherein a third party VPN service is offered as a secure deployment vehicle or wherein a VPN is build on-demand as required for a specific deployment. A virtual private network (VPN) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-free number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a companies multiple fixed sites over a public network such as the Internet.

The process software is transported over the VPN via tunneling which is the process of placing an entire packet within another packet and sending it over a network. The protocol of the outer packet is understood by the network and both points, called tunnel interfaces, where the packet enters and exits the network.

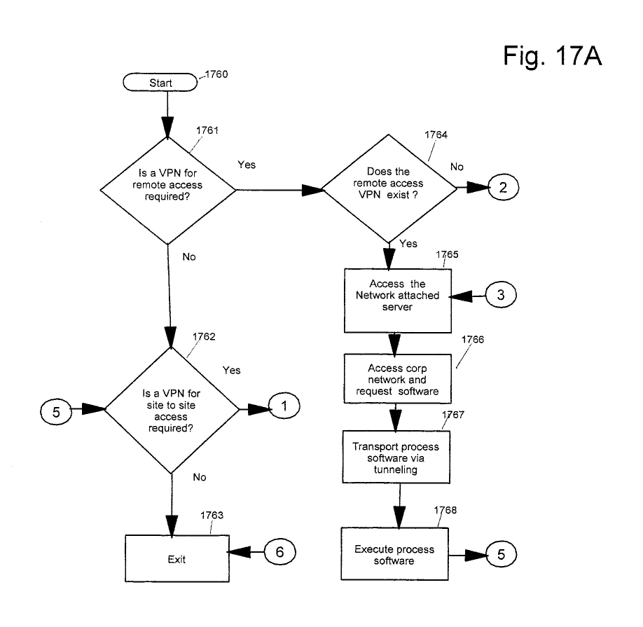

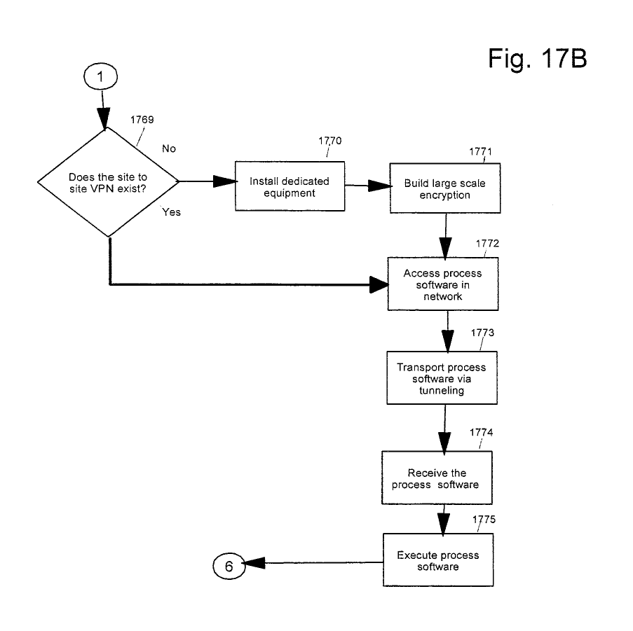

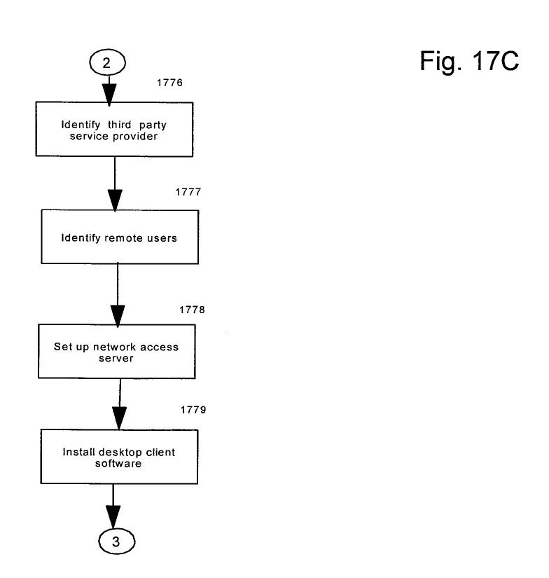

FIGS. 17A, 17B and 17C illustrate the VPN software deployment implementation for using an integrated approach in an end-to-end process according to an embodiment of the present invention. Step 1760 begins the Virtual Private Network (VPN) process. A determination is made to see if a VPN for remote access is required 1761. If it is not required, then proceed to 1762. If it is required, then determine if the remote access VPN exists 1764.

If a VPN does exist, then proceed to 1775. Otherwise identify a third party provider that will provide the secure, encrypted connections between the company's private network and the company's remote users 1776. The company's remote users are identified 1777. The third party provider then sets up a network access server (NAS) 1778 that allows the remote users to dial a toll free number or attach directly via a broadband modem to access, download and install the desktop client software for the remote-access VPN 1779.

After the remote access VPN has been built or if it been previously installed, the remote users can access the process software by dialing into the NAS or attaching directly via a cable or DSL modem into the NAS 1765. This allows entry into the corporate network where the process software is accessed 1766. The process software is transported to the remote user's desktop over the network via tunneling. That is the process software is divided into packets and each packet including the data and protocol is placed within another packet 1767. When the process software arrives at the remote user's desktop, it is removed from the packets, reconstituted and then is executed on the remote users desktop 1768.

A determination is made to see if a VPN for site to site access is required 1762. If it is not required, then proceed to exit the process 1763. Otherwise, determine if the site to site VPN exists 1769. If it does exist, then proceed to 1772. Otherwise, install the dedicated equipment required to establish a site to site VPN 1770. Then build the large scale encryption into the VPN 1771.

After the site to site VPN has been built or if it had been previously established, the users access the process software via the VPN 1772. The process software is transported to the site users over the network via tunneling. That is the process software is divided into packets and each packet including the data and protocol is placed within another packet 1774. When the process software arrives at the remote user's desktop, it is removed from the packets, reconstituted and is executed on the site users desktop 1775. Proceed to exit the process 1763.

It is to be understood that the provided illustrative examples are by no means exhaustive of the many possible uses for my invention.

From the foregoing description, one skilled in the art can easily ascertain the essential characteristics of this invention and, without departing from the spirit and scope thereof, can make various changes and modifications of the invention to adapt it to various usages and conditions.

It is to be understood that the present invention is not limited to the embodiments described above, but encompasses any and all embodiments within the scope of the following claims:

We claim:

1. A method for implementing a repository of services, comprising:
defining a plurality of atomic services;
providing at least one service composition from said definition of said plurality of atomic services; and
combining at least one atomic service associated with said at least one service composition with a service plan, wherein said service plan describes the control and data flow between said at least one of said plurality of atomic services and said at least one service composition.

2. The method of claim 1, further comprises:
providing a repository of service providers;
providing a repository of service provider capabilities of delivering said atomic services;
conducting an extended service order process by accessing said at least one service composition;
retrieving said service plan of said at least one service composition;
retrieving said repository of service provider capabilities;
selecting at least one of said service providers for each atomic service definition; and
executing said service plan by invoking said at least one atomic services offered by said at least one of said selected service providers according to a control flow of said service plan as part of said at least one service composition.

3. The method of claim 1, further comprises:
providing a repository of account records that represent as offered services for each account a set of service compositions to which said accounts are subscribed and the account-specific requirements of each said account on service compositions.

4. The method of claim 3, wherein said providing of said repository of account records further comprises:
including a choice of preferred service providers for each said account.

5. The method of claim 2, further comprises:
providing an end-to-end life-cycle management for each repository.

6. The method of claim 5, wherein the providing of an end-to-end life cycle management includes providing an atomic service definition life-cycle.

7. The method of claim 5, wherein the providing of an end-to-end life cycle management includes providing a service provider capability life-cycle.

8. The method of claim 5, wherein the providing of an end-to-end life cycle management includes providing a service composition life-cycle.

9. The method of claim 5, wherein the providing of an end-to-end life cycle management includes providing an offered service life-cycle.

10. A method for executing a composite service in a repository of services, comprising:
defining a plurality of atomic services;
providing at least one service composition from said definition of said plurality of atomic services;
combining at least one atomic service with a service plan, said service plan describes the control and data flow between said at least one of said plurality of atomic services and said at least one service composition; and
executing a service order process by accessing a service composition repository, retrieving said service plan of said one of a said plurality of service composition in said service composition repository, and executing said service plan by invoking said at least one atomic services according to the said control flow of the said service plan of the said at least one service composition.

11. The method of claim 10 further comprises:
adding a plurality of constraints to the said at least one service composition; and
validating said at least one service composition of said plurality of atomic services into a service composition regarding quality of service.

12. A computer-based method for a multiparty electronic service, comprising:
defining a plurality of atomic services;
providing at least one service composition from said definition of said plurality of atomic services; and
combining at least one atomic service associated with said at least one service composition with a service plan, wherein said service plan describes the control and data flow between said at least one of said plurality of atomic services and said at least one service composition.

13. The method of claim 12, further comprises:
providing a repository of account records that represent as offered services for each account a set of service compositions to which said accounts are subscribed and the account-specific requirements of each said account on service compositions.

14. The method of claim 13, wherein said providing of said repository of account records further comprises:
including a choice of preferred service providers for each said account.

15. Apparatus for an electronic service, comprising:
at least one host computer adapted to be controlled by an operating system, said at least one host computer operative to: define a plurality of atomic services; provide at least one service composition from said definition of said plurality of atomic services;
and combine at least one atomic service associated with said at least one service composition with a service plan, wherein said service plan describes the control and data flow between said at least one of said plurality of atomic services and said at least one service composition.

16. The apparatus of claim 15, further comprises:
a repository of service providers;
a repository of service provider capabilities of delivering said atomic services;
means for conducting an extended service order process by accessing said at least one service composition;
means for retrieving said service plan of said at least one service composition;
retrieving said repository of service provider capabilities;
means for selecting at least one of said service providers for each atomic service definition; and
means for executing said service plan by invoking said at least one atomic services offered by said at least one of said selected service providers according to a control flow of said service plan as part of said at least one service composition.

17. The apparatus of claim 15, further comprises:
a repository of account records that represent as offered services for each account a set of service compositions to which said accounts are subscribed and the account-specific requirements of each said account on service compositions.

18. A program storage device readable by a machine, tangibly embodying a program of instructions executable by the machine to perform a method comprising:
defining a plurality of atomic services;
providing at least one service composition from said definition of said plurality of atomic services; and
combining at least one atomic service associated with said at least one service composition with a service plan, wherein said service plan describes the control and data flow between said at least one of said plurality of atomic services and said at least one service composition.
